(19) United States
(12) Patent Application Publication
(10) Pub. No.: US 2015/0196056 A1
(43) Pub. Date: Jul. 16, 2015

(54) ELECTRONIC CIGARETTE AND ASSEMBLY METHOD OF ATOMIZER THEREOF

(71) Applicant: KIMREE HI-TECH INC., Tortola (VG)

(72) Inventor: Qiuming Liu, Huizhou City (CN)

(21) Appl. No.: 14/412,426

(22) PCT Filed: Apr. 22, 2013
(86) PCT No.: PCT/CN2013/074522

§ 371 Date: Dec. 31, 2014

(51) Int. Cl. A24F 47/00; H05B 1/02

(52) U.S. Cl. CPC A24F 47/008; H05B 1/0244

(57) ABSTRACT

An electronic cigarette and a method for assembling an atomizer thereof. The electronic cigarette comprises a suction rod (10) and a power supply rod (20). The suction rod (10) comprises a suction tube (11) and an atomizer (12) disposed in the suction tube (11) and used for generating smoke. The atomizer (12) comprises an air pipe (122) and a heating assembly (123). The air pipe (122) is provided with a through hole (100) along a radial direction used for accommodating and fixing the heating assembly (123). The air pipe (122) is also provided with a notch (200) which has a bottom communicating with the through hole (100) and is used for assembling the heating assembly. By disposing a notch (200) which has a bottom communicating with the through hole (100) and is used for assembling the heating assembly (123) on the air pipe (122), technical effects of simple assembly, high efficiency, stable quality and cost saving are achieved.

### FIELD OF THE INVENTION

The invention relates to an electronic cigarette and a method for assembling atomizer thereof

### BACKGROUND OF THE INVENTION

An electronic cigarette is a simulated cigarette in which substance containing essence is atomized due to heating of an electric heating wire thus resulting in smoke to be inhaled by a user. Please refer to FIG. 1 and FIG. 2, assembling process of existing electronic cigarette atomizer is: first winding electric heating wire on a glass fiber wire 1, cutting the electric heating wire at a predetermined length, then guiding the glass fiber wire 1 wound with electric heating wire through a first venting tube 2 with openings, subsequently sleeving a second venting tube 3 on the outside of the first venting tube 2 to abut tightly against the glass fiber wire 1 so as to prevent the electric heating wire from loosing, and riveting the both ends of the electric heating wire and an electronic wire, finally coating with non-woven cloth, oil-storage medium etc.

However, when the electric heating wire is guided through the venting tube opening, adjacent two cycles are pushed and readily contact to cause the resistance of the electric heating wire to decrease, which reduces the service life of the electronic cigarette and affects the quality consistency of the electronic cigarette with other electronic cigarettes; moreover, the glass fiber wire 1 is easy to break due to force when being guided through the through hole. Accordingly, the existing electronic cigarette atomizer engages: complicated assembly process, low efficiency, prone to poor product and waste of human and material resources.

### SUMMARY OF THE INVENTION

In view of this, the present invention provides an electronic cigarette and an assembling method for atomizer thereof, with simple assembly process, high efficiency, stable quality and saving of human and material costs.

To achieve the above object, the present invention provides an electronic cigarette including a sucking rod and a power rod, wherein the sucking rod includes a sucking cylinder and an atomizer provided in the sucking cylinder and used for producing smoke, the atomizer includes a venting tube and a heating component, the venting tube is radially provided with a through hole for accommodating and fixing the heating component, the venting tube is also provided with a cut thereon which is communicating to the through hole at bottom and used for assembling the heating component. Specifically, the through hole is a round hole without apparent sharp angles, which is not likely to break when being pulled to open from the cut which is communicating to the through hole at bottom. In conclusion, via the cut of the opening in the venting tube, the venting tube can be pulled to open and bended smoothly, so that the heating component can be placed in conveniently and quickly; in addition, relative to the straight groove of the horizontal opening, after the cut of the present embodiment is pulled to open the opening upward faces to the operating person, which facilitates the operating person to place in the heating component from the view point of human-mechanics and accelerates assembly speed.

Furthermore, the cross section of the cut axially cut along the venting tube is shaped as an oblique line.

Furthermore, the cross section of the cut axially cut along the venting tube is shaped as an obtuse-angle broken line.

Furthermore, the cross section of the cut axially cut along the venting tube is shaped as a right-angle broken line.

Furthermore, the corner of the cut is formed with a smooth chamfer angle. Thus, the way of setting the chamfer angle reduces the friction resistance when installing the heating component, and further facilitates a rapid assembly.

Furthermore, the venting tube is a glass fiber tube, cotton fiber tube or soft rubber tube.

Furthermore, the width of the cut is smaller than the diameter of the through hole, thus the cut-away material of the cut is relative less, which is more beneficial for remaining the original status of the venting tube, and remaining the gripping and fixing of the heating component well after assembly is accomplished.

Furthermore, the sucking rod further includes a mouthpiece cover disposed on one end of the sucking cylinder, and a first connector disposed on the other end of the sucking cylinder and used for connecting with the power rod.

Furthermore, the power rod includes a power cylinder and a power source provided in the power cylinder, one end of the power cylinder is provided with a second connector matching with the first connector and the other end is provided with a switch module and a lamp-cap component.

Furthermore, the first connector and the second connector are both composed of an outer electrode ring, an insulating ring and an inner electrode sleeved in sequence.

Furthermore, the atomizer includes an atomization cavity composed of a liquid-storage member, a liquid guiding member and a venting tube sleeved in sequence and closed at both ends, the heating component is disposed in the atomization cavity; wherein, the two ends of the atomization cavity are closed by the mouthpiece cover and the outer electrode ring respectively.

In addition, the invention also provides an assembly method based on the above electronic cigarette atomizer, which includes: an installing step: pulling to open the venting tube in order to enlarge the cut, and installing the heating component along the cut, and; a returning step: loosing the venting tube to make the cut return and accommodate to fix the heating component. Thus, relative to the multi-step assembly of existing electronic cigarettes which requires two venting tubes, the assembly method of the atomizer in the present embodiment only employs one venting tube, and only one time of pulling to open and loosing is enough to accomplish the assembly. The method benefits simple and quick assembly, unlikely to damage the heating component, ensuring the quality, stable quality and saving of human and material costs.

Furthermore, prior to the installing step further included is: a preparing step: on the venting tube disposing a through hole and disposing a cut communicating to the through hole at bottom. Specifically, it can be done by punching a hole and cut a groove on the venting tube with a punching die. The through hole is radially provided along the venting tube, and the diameter thereof matches with the diameter of the heating component.

Furthermore, after the returning step further included is: a wire connecting step: riveting the both ends of the electric heating wire with a metal tube. Specifically, the electronic cigarettes of embodiments in the present invention are divided into two types: one is disposable electronic cigarette, that is, an integrated structure with a sucking rod and a power rod being both disposable and connecting to each other, the two ends of the electric heating wire are riveted respectively to a copper tube bearing conducting wires, specifically the electric heating wire is guided into the tube opening and fixed in the copper tube, and then one conducting wire is welded to a battery after passing through an integrated microphone switch (that is, a switch module), the other conducting wire is welded directly to the battery; the other type is multiple use electronic cigarette, that is, a multiple use power rod is engaged to a sucking rod provided with a disposable atomizer, the power source can be used repeatedly, and the sucking rod can be changed promptly after using, the two ends of the electric heating wire are riveted respectively to a copper tube bearing conducting wires, specifically are guided into the tube opening and fixed in the copper tube, then the conducting wires are separately pressed tightly or welded on the inner and outer electrodes.

The advantages of the electronic cigarette of the present invention and the assembly of the atomizer thereof are that: by employing the technical means of providing a cut on the venting tube which is communicating to the through hole at bottom and used for installing the heating component, technical effects of simple assembly, high efficiency, stable quality and saving of human and material costs are thus achieved.

### BRIEF DESCRIPTION OF THE DRAWINGS

FIG. 1 is a schematic diagram illustrating a local structure of an atomizer of existing electronic cigarette.

FIG. 2 is a schematic diagram illustrating the assembly process of an atomizer of existing electronic cigarette as shown in FIG. 1.

FIG. 3 is a schematic diagram illustrating the integral structure of the electronic cigarette in embodiments of the present invention.

FIG. 4 is a cross-sectional view of the electronic cigarette as shown in FIG. 3 along A-A line.

FIG. 5 is a front view illustrating the structure of a venting tube in a first embodiment of the present invention.

FIG. 6 is a cross-sectional view of the venting tube as shown in FIG. 5 along B-B line.

FIG. 7 is a schematic diagram illustrating the structure of a first venting tube in a second embodiment of the present invention.

FIG. 8 is a schematic diagram illustrating the structure of another venting tube in the second embodiment of the present invention.

FIG. 9 is a schematic diagram illustrating the structure of yet another venting tube in the second embodiment of the present invention.

FIG. 10 is a schematic diagram illustrating the structure of a venting tube in a third embodiment of the present invention.

FIG. 11 is a schematic diagram illustrating the installing step of the assembly method of the atomizer in the present invention.

FIG. 12 is a schematic diagram illustrating the returning step of the assembly method of the atomizer in the present invention.

FIG. 13 is a schematic diagram illustrating the heating component after installation in the assembly method of the atomizer in the present invention.

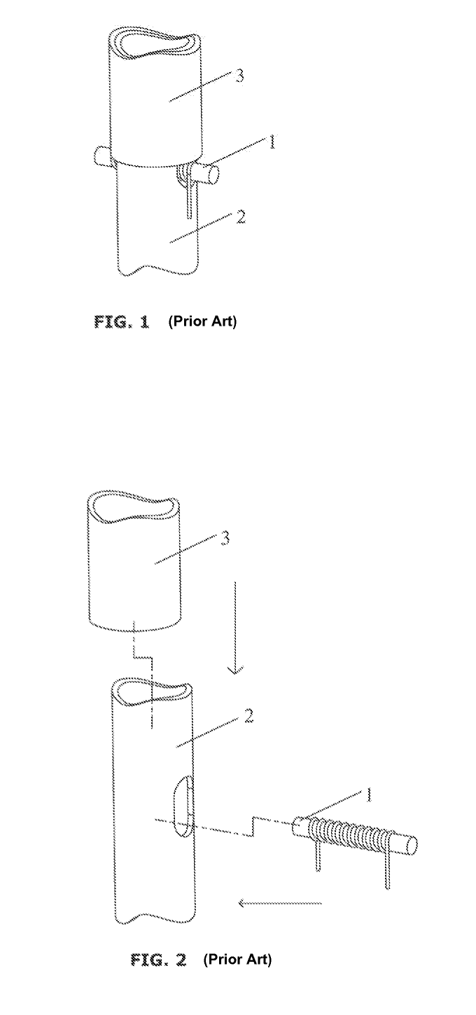

### DETAILED DESCRIPTION OF THE INVENTION

It is noted that, in case no interference is resulted in, the embodiments and features contained therein may be combined with each other. The present invention is described in greater detail in conjunction with the accompanying drawings and embodiments.

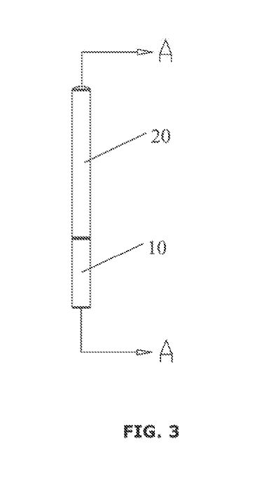

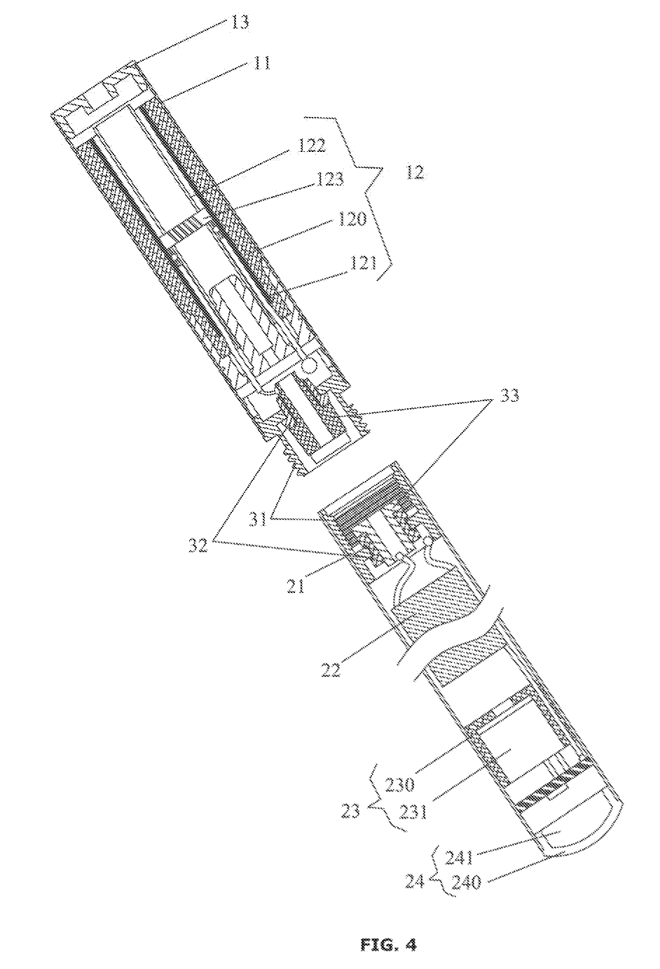

Please refer to FIG. 3 and FIG. 4, the present invention provides an electronic cigarette including a sucking rod 10 and a power rod 20 connecting to each other, the atomizer thereof has a simple structure and is easy to be assembled with high efficiency, stable quality and saving of human and material costs.

The sucking rod 10 includes an sucking cylinder 11 shaped as a cylinder, an atomizer 12 for producing smoke provided in the sucking cylinder 11, a mouthpiece cover 13 provided on one of the sucking cylinder 11, a first connector provided on the other end of the sucking cylinder 11 and used for connecting with the power rod 20. In the present embodiment, the outer surface of the sucking cylinder 11 is also sleeved with adhesive paper (not shown).

The atomizer 12 includes an atomization cavity composed of a liquid-storage member 120, a liquid guiding member 121 and a venting tube 122 sleeved in sequence and closed at both ends, and a heating component 123 disposed in the atomization cavity; wherein, the two ends of the atomization cavity are closed by the mouthpiece cover 13 and an outer electrode ring 31 respectively. The heating component 123 includes a liquid guiding rod 1230 extending out of the outer side wall of the venting 122 at both ends and abutting to the liquid guiding member 121, and an electric heating wire 1231 winding around the outer surface of the liquid guiding rod 1230, two ends of the electric heating wire 1231 being electrically connected to an inner electrode 33 and the outer electrode ring 31. In the present embodiment, the liquid-storage member 120 is oil-storage cotton, the liquid guiding member 121 is nonwoven cloth, the venting tube 122 is yellow nano pipe also known as glassfiber tube; the liquid guiding rod 1230 is glass fiber wire.

The power rod 20 includes a power cylinder 21 and a power source 22 provided in the power cylinder 21, one end of the power cylinder 21 is provided with a second connector matching with the first connector and the other end is provided with a switch module 23 and a lamp-cap component 24. The switch module 23 includes a support 230 and a gas flow sensor 231 fixed to the support 230. The lamp-cap component 24 includes a lamp-cap 240 and an LED lamp 241 provided to the inner side thereof and used for indicating the status of simulated flaming cigarette.

The first connector and the second connector are both composed of an outer electrode ring 31, an insulating ring 32 and an inner electrode 33 sleeved in sequence. Wherein, the insulating ring 32 is used for the insulation between the outer electrode ring 31 and the inner electrode 33.

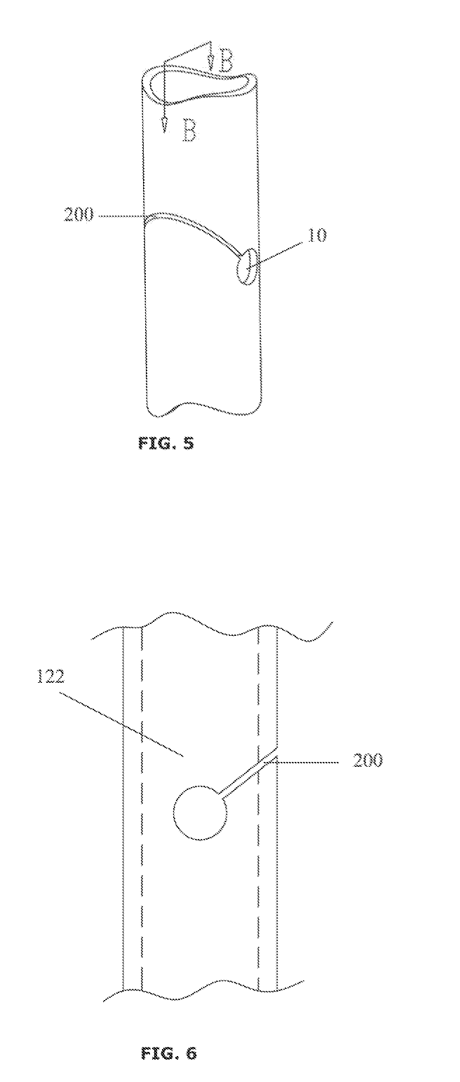

Please refer to FIG. 5 and FIG. 6, in the present embodiment, the venting tube 122 is a glass fiber tube, cotton fiber tube or soft rubber tube, radially provided with a through hole 100 for accommodating and fixing the heating component 123, on the venting tube 122 is also provided with a cut 200 communicating to the through hole 100 at bottom and used for assembling the heating component 123. The cut 200 corresponds to the cutting line in the venting tube 122 and is perpendicular to the axis of the venting tube 122; the width of the cut 200 is smaller than the diameter of the through hole 100, the cross section of the cut 200 axially cut along the venting tube 122 is shaped as an oblique line.

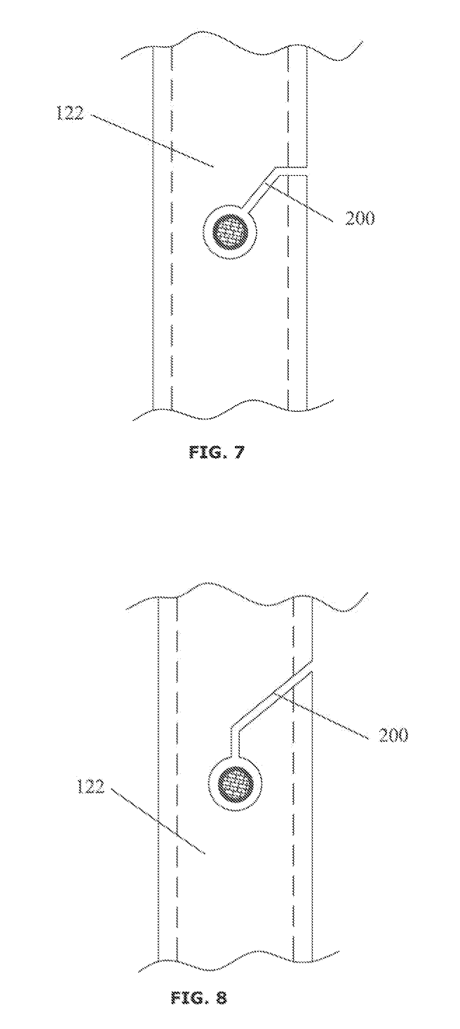

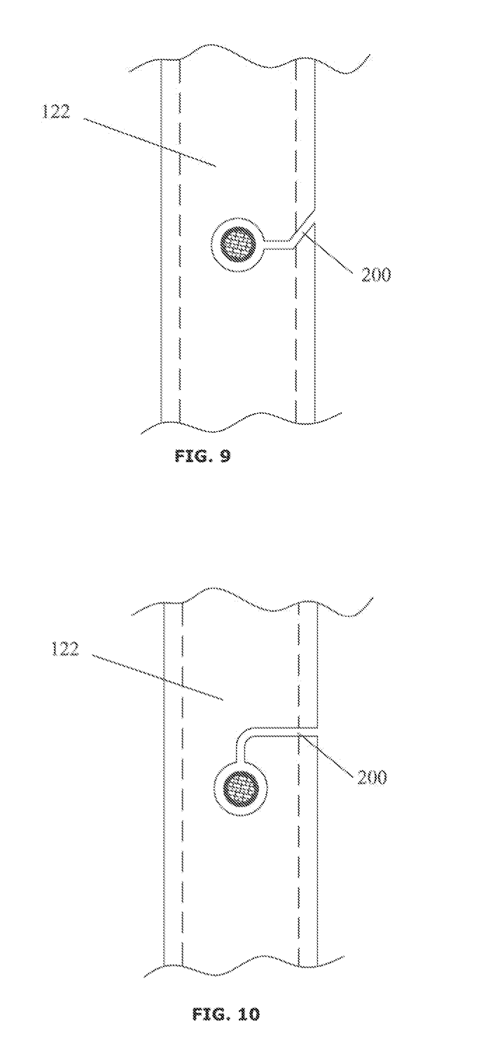

As an embodiment, please refer to FIGS. 7 to 9, the cross section of the cut 200 axially cut along the venting tube 122 is shaped as an obtuse-angle broken line.

As an embodiment, the cross section of the cut 200 axially cut along the venting tube 122 is shaped as a right-angle broken line. Preferably, please refer to FIG. 10, the corner of the cut 200 is formed with a smooth chamfer angle.

The present invention also provides an assembly method of the atomizer of an electronic cigarette, the method including:

a preparing step: on the venting tube 122 disposing a through hole 100 and disposing a cut 200 communicating to the through hole 100 at bottom;

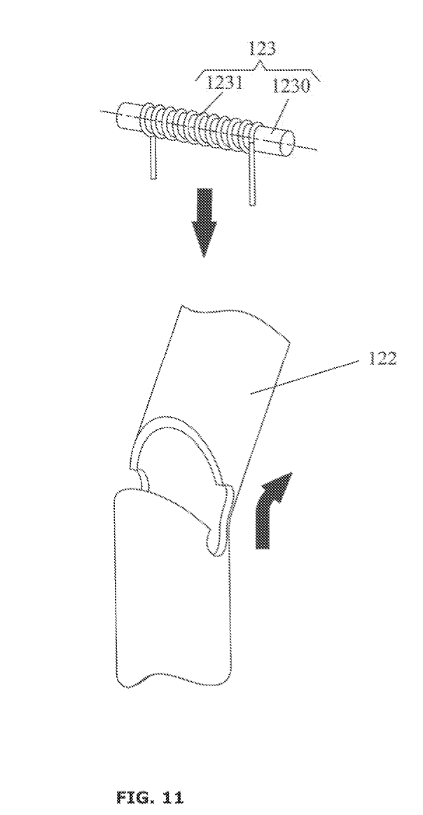

an installing step (as shown in FIG. 11): pulling to open the venting tube 122 in order to enlarge the cut, and installing the heating component along the cut 200;

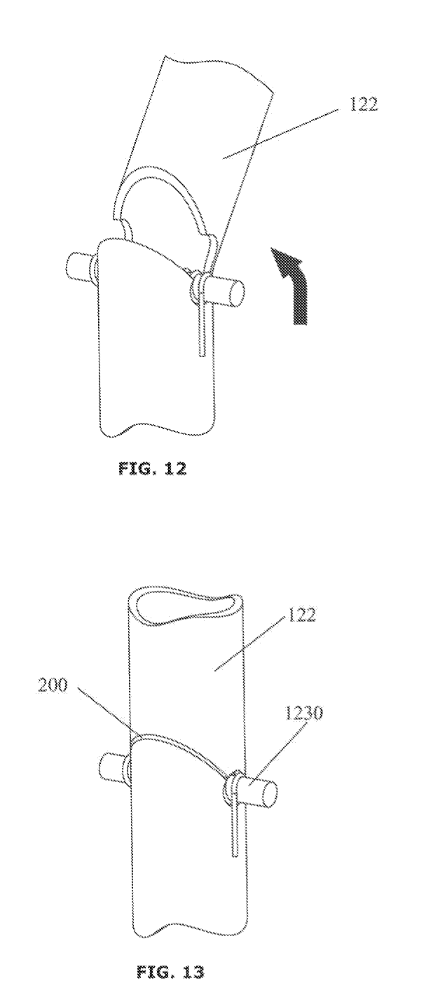

a return step (as shown in FIG. 12): loosing the venting tube 122 to make the cut return and accommodate to fix the heating component 123, the returned venting tube 122 is as shown in FIG. 13;

a wire connecting step: riveting the both ends of the electric heating wire 1231 with a metal tube. Specifically, the assembly step prior to the preparing step and the assembly step after the wire connecting step are both prior arts and will not be described.

While the embodiments of the present invention have been illustrated and described, it will be understood that various changes, amendments, substitutions, and modifications can be made by those skilled in the art without departing from the principle and the spirit of the embodiments of the present invention, and it is intended that the scope of the invention be defined by the Claims appended hereto and their equivalents.

What is claimed is:

1. An electronic cigarette including a sucking rod, the sucking rod including a sucking cylinder and an atomizer provided in the sucking cylinder and used for producing smoke, the atomizer including a venting tube and a heating component, the venting tube being radially provided with a through hole for accommodating and fixing the heating component, characterized in that the venting tube is also provided with a cut thereon which is communicating to the through hole and used for assembling the heating component.

2. The electronic cigarette according to claim 1, characterized in that the cross section of the cut axially cut along the venting tube is shaped as an oblique line.

3. The electronic cigarette according to claim 1, characterized in that the cross section of the cut axially cut along the venting tube is shaped as obtuse-angle broken line.

4. The electronic cigarette according to claim 1, characterized in that the cross section of the cut axially cut along the venting tube is shaped as right-angle broken line.

5. The electronic cigarette according to claim 4, characterized in that the corner of the cut is formed with a smooth chamfer angle.

6. The electronic cigarette according to claim 1, characterized in that the venting tube is glass fiber tube, cotton fiber tube or soft rubber tube.

7. The electronic cigarette according to claim 1, characterized in that the width of the cut is smaller than the diameter of the through hole.

8. The electronic cigarette according to claim 1, characterized in that, the electronic cigarette further includes a power rod; the sucking rod further includes a mouthpiece cover disposed on one end of the sucking cylinder, and a first connector disposed on the other end of the sucking cylinder and used for connecting with the power rod.

9. The electronic cigarette according to claim 8, characterized in that, the power rod includes a power cylinder and a power source provided in the power cylinder, one end of the power cylinder is provided with a second connector matching with the first connector and the other end is provided with a switch module and a lamp-cap component.

10. The electronic cigarette according to claim 9, characterized in that, the first connector and the second connector are both composed of an outer electrode ring, an insulating ring and an inner electrode sleeved in sequence.

11. The electronic cigarette according to claim 10, characterized in that, the atomizer includes an atomization cavity composed of a liquid-storage member, a liquid guiding member and a venting tube sleeved in sequence and closed at both ends, the heating component is disposed in the atomization cavity; wherein, the two ends of the atomization cavity are closed by the mouthpiece cover and the outer electrode ring respectively.

12. An assembly method of atomizer of an electronic cigarette according to any one of claims 1 to 10, characterized in that, the method includes:
an installing step: pulling to open the venting tube in order to enlarge the cut, and installing the heating component along the cut; and
a returning step: loosing the venting tube to make the cut return and accommodate to fix the heating component.

13. The assembly method according to claim 12, characterized in that, prior to the installing step further including:
a preparing step: on the venting tube disposing a through hole and disposing a cut communicating to the through hole at bottom.

14. The assembly method according to claim 12, characterized in that, after the returning step further including:
a wire connecting step: riveting the both ends of the electric heating wire with a metal tube.
